(19) United States
(12) Patent Application Publication
(10) Pub. No.: US 2024/0072279 A1
(43) Pub. Date: Feb. 29, 2024

(54) Hydrogen Storage Assembly

(71) Applicant: Purem GmbH, Neunkirchen (DE)

(72) Inventors: Jochen Hammer, Stuttgart (DE); Lisa Zimmermann, Esslingen (DE); Heike Többen, Uhingen (DE); Philipp Weinmann, Esslingen (DE)

(21) Appl. No.: 18/455,363

(22) Filed: Aug. 24, 2023

(30) Foreign Application Priority Data
Aug. 25, 2022 (DE) 10 2022 121 458.3

(51) Int. Cl. H01M 8/04082; B01D 53/02; B01D 53/86; F17C 1/00; H01M 8/0662

(52) U.S. Cl. CPC H01M 8/04201; B01D 53/02; B01D 53/8671; F17C 1/00; H01M 8/0662; B01D 2253/108; B01D 2253/1122; B01D 2255/1021; B01D 2255/1023; B01D 2257/108; F17C 2221/012; F17C 2270/0168; F17C 2270/0184; H01M 2250/20

(57) ABSTRACT

A hydrogen storage assembly, in particular for a fuel cell system in a vehicle, includes at least one hydrogen tank for storage of liquid hydrogen and at least one hydrogen sorption/catalyst unit for sorption and catalytic conversion of gaseous hydrogen released from the at least one hydrogen tank. Also, a fuel cell system includes the hydrogen storage assembly.

### CROSS-REFERENCE TO RELATED APPLICATIONS

This application claims priority of German patent application no. 10 2022 121 458.3, filed Aug. 25, 2022, the entire content of which is incorporated herein by reference.

### TECHNICAL FIELD

The present disclosure relates to a hydrogen storage assembly which makes it possible for example to store hydrogen in a fuel cell system provided for producing electrical energy in a vehicle.

### BACKGROUND

In hydrogen storage assemblies utilized for example in vehicles to provide hydrogen for the fuel cell process in a fuel cell system, the hydrogen is stored at very low temperatures of below −250° C. in the liquid state of matter in at least one hydrogen tank. Due to heat input which is unavoidable despite very good insulation, lack of use of such a fuel cell system for a prolonged period results in the formation of gaseous hydrogen in such hydrogen tanks, generally also known as cryotanks, thus leading to a pressure increase which requires controlled release in procedures performed on a cyclic basis for example to avoid an excessively high pressure increase in such a hydrogen tank above a value of about 20 bar for example.

### SUMMARY

It is an object of the present disclosure to provide a hydrogen storage assembly, in particular fora fuel cell system in a vehicle, in which the release of excessively highly concentrated gaseous hydrogen to the environment can be avoided.

This object is achieved according to the disclosure by a hydrogen storage assembly, in particular for a fuel cell system in a vehicle, including at least one hydrogen tank for storage of liquid hydrogen and at least one hydrogen sorption/catalyst unit for sorption and catalytic conversion of gaseous hydrogen released from the at least one hydrogen tank.

The hydrogen storage assembly constructed according to the disclosure utilizes two processes to avoid the release of excessively concentrated gaseous hydrogen to the environment. It firstly utilizes a sorption process in which, when gaseous hydrogen is released from the at least one hydrogen tank and is not reacted in a fuel cell to produce electrical energy, the hydrogen is temporarily sorbed. The sorbed hydrogen or at least a substantial portion thereof may subsequently be oxidized in a catalytic process and for example reacted with atmospheric oxygen to form water. The hydrogen storage assembly according to the disclosure can utilize the energy liberated in the form of heat in the sorption process to increase the temperature of the hydrogen sorption/catalyst unit to a temperature in the range of or above the reaction temperature of the catalytic process. The sorption of hydrogen can thus activate the catalytic process which itself also liberates energy, thus making it possible, without external supply of energy, to react the gaseous hydrogen released from the at least one hydrogen tank and to avoid the release from the at least one hydrogen tank of highly concentrated hydrogen which is thus potentially critical in terms of explosion risk in the release of gaseous hydrogen.

In order to be able to provide a sufficiently large surface area for the sorption and catalytic reaction of hydrogen it is proposed that the at least one hydrogen sorption/catalyst unit includes at least one substrate around which gaseous hydrogen can flow, wherein hydrogen sorption material and hydrogen catalyst material are provided at the substrate.

The at least one substrate may be constructed with ceramic material for example and/or the at least one substrate may include a multiplicity of flow channels through which gaseous hydrogen can flow. This substrate may in particular have a honeycomb structure having a plurality of substantially linearly extending flow channels. In an alternative embodiment the substrate may be in the form of a porous body, so that the flow channels are formed in the porous structure of the substrate.

For interaction with the gaseous hydrogen released from the at least one hydrogen tank the at least one substrate may include the hydrogen sorption material and the hydrogen catalyst material on its surface defining the flow channels.

To achieve this at least a portion of a substrate surface of the at least one substrate may be coated with the hydrogen sorption material and the hydrogen catalyst material may be provided on at least one surface of the hydrogen sorption material.

In order to be able to rapidly activate the catalytic process to be performed for reaction of the hydrogen especially even at very low ambient temperatures it is proposed that a heating unit is assigned to the at least one substrate. The heating unit may be electrically energizable to provide heat.

In an advantageous embodiment the at least one hydrogen sorption/catalyst unit may be configured for adsorption of hydrogen.

In order to be able to utilize the process of physical incorporation of hydrogen into the lattice structure of the hydrogen sorption material it is proposed that the hydrogen sorption material includes physisorption material. As a material particularly suitable for the incorporation of hydrogen the physisorption material may include zeolite.

In order in an alternative embodiment to be able to utilize the process of chemical adsorption of hydrogen onto the hydrogen sorption material the hydrogen sorption material may include chemisorption material. To this end the chemisorption material may for example include a metal hydride-forming metal, for example lithium, a mixture of lithium and aluminum or a mixture of sodium and boron.

The at least one hydrogen sorption/catalyst unit may be configured for catalytic oxidation of hydrogen. To this end the hydrogen catalyst material may include palladium and/or platinum.

The disclosure further relates to a fuel cell system, in particular for a vehicle, including at least one fuel cell and a hydrogen storage assembly constructed according to the disclosure for supplying gaseous hydrogen to an anode region of the at least one fuel cell.

### BRIEF DESCRIPTION OF DRAWINGS

The invention will now be described with reference to the drawings wherein:

FIG. 1 is a representation in principle of a fuel cell system for a vehicle for example;

FIG. 2 is a sectional representation in principle of a hydrogen sorption/catalyst unit of the fuel cell system of FIG. 1; and,

FIG. 3 is a front end view of a substrate, around which the hydrogen can flow, of the hydrogen sorption/catalyst unit of FIG. 2.

### DETAILED DESCRIPTION

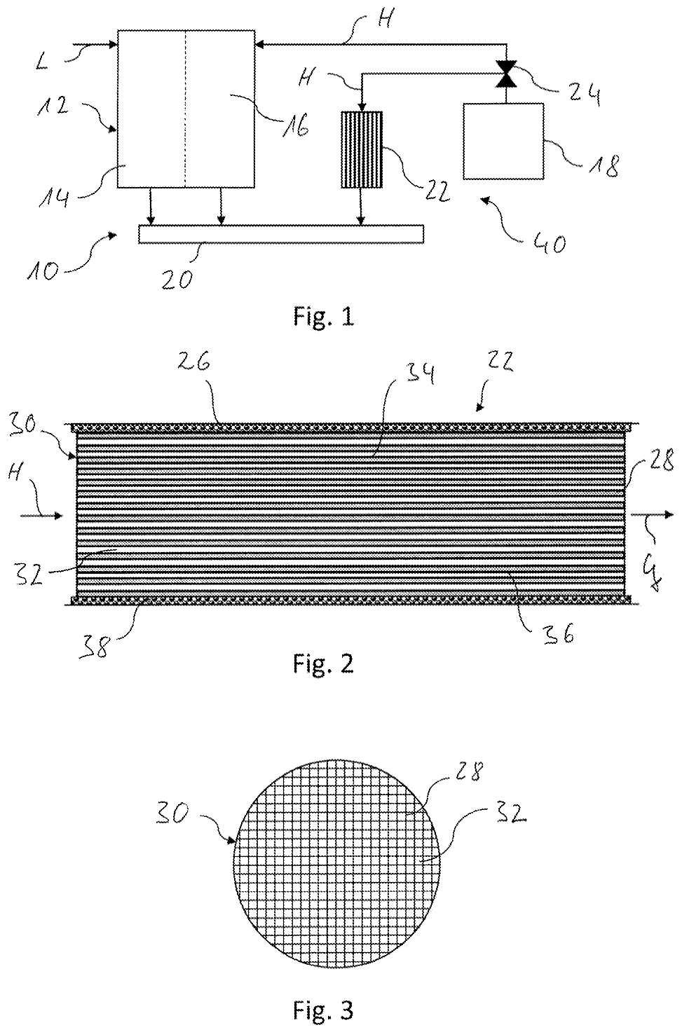

A fuel cell system 10 shown in FIG. 1 may for example be utilized to provide electrical energy for propulsion of drive motors and to supply further consumers of electrical energy in a vehicle. The fuel cell system 10 includes a fuel cell 12 as the central system region. A cathode region 14 of the fuel cells 12 is supplied with oxygen/an oxygen-containing gas L, for example air. An anode region 16 of the fuel cell 12 is supplied from one or more hydrogen tanks 18 with gaseous hydrogen H, that is, molecular hydrogen H2. The hydrogen and the oxygen are reacted in the fuel cell 14 to produce electrical energy. Fuel cell exhaust gas exiting the cathode region 14 and the anode region 16 can be released to the environment via a fuel cell exhaust gas apparatus 20. The fuel cell exhaust gas apparatus 20 can for example separate out water entrained in the fuel cell exhaust gas or steam present therein before release to the environment, thus making it possible to prevent formation of mist at an outlet region of the fuel cell exhaust gas system 20.

The fuel cell system 10 shown in FIG. 1 further includes a hydrogen sorption/catalyst unit 22. This may be in communication with the hydrogen tank 18 via a valve assembly 24 and together with the hydrogen tank forms the essential system region of a hydrogen storage assembly 40.

In the hydrogen tank 18 the hydrogen required for the fuel cell process is stored at very low temperature in the liquid state of matter. After a prolonged period of downtime of the fuel cell system 12 gaseous hydrogen requiring discharging from the hydrogen tank 18 may be formed above the liquid hydrogen in the interior of the hydrogen tank 18. To blow off gaseous hydrogen H from the hydrogen tank 18 the valve assembly 24 passes the gaseous hydrogen H to the hydrogen sorption/catalyst unit 22. As shown schematically in FIGS. 2 and 3, the unit includes a substrate 30 which is accommodated in a housing 26 which is tubular for example and is monolithically constructed with ceramic material 28. Formed in the substrate 30 are a multiplicity of flow channels 32, through which gas, in particular the gaseous hydrogen H released from the hydrogen tank 18 via the valve assembly 24, can flow. The flow channels 32 may extend linearly in the substrate 30 and have a polygonal cross-sectional contour in the manner of a honeycomb structure.

At its surface defining the flow channels 32 the ceramic material 28 of the substrate 30 is coated at least in some regions with hydrogen sorption material 34. Hydrogen catalyst material 36 is provided at/incorporated into the surface of the hydrogen sorption material 34. The hydrogen sorption material serves to bind the gaseous hydrogen H introduced into the flow channels 32 by adsorption at the substrate 30, so that in particular at commencement of such a process for releasing gaseous hydrogen from the hydrogen tank 18 no highly concentrated hydrogen gas is emitted to the environment via the hydrogen sorption/catalyst unit 22. The hydrogen catalyst material 36 with which the hydrogen sorption material 34 is doped serves to oxidize the gaseous hydrogen H in the catalytic process and for example effect reaction thereof with atmospheric oxygen to form water.

The adsorption of hydrogen at the hydrogen sorption material liberates energy in the form of heat. This energy liberated in the form of heat has the result that the hydrogen catalyst material 36 provided at/incorporated into the hydrogen sorption material 34 is heated and brought to a temperature in the range of/above the reaction temperature at which the catalytically induced oxidation of hydrogen proceeds and which may have a value of about 100° C. or below. Further hydrogen H introduced into the substrate 30 is thus catalytically reacted so that a hydrogen-depleted and for example water/steam-containing gas G is released from the hydrogen sorption/catalyst unit 22. Similarly to the fuel cell exhaust gas, this hydrogen-depleted gas G may for example be introduced into the fuel cell exhaust gas apparatus 20 in order to separate water/steam therefrom and thus release a gas substantially freed of water and steam to the environment.

The catalytic reaction of hydrogen started by the energy liberated in the adsorption process likewise liberates energy in the form of heat which results in further heating of not only the hydrogen catalyst material 36 but also the hydrogen sorption material 34. Especially through the heating of the hydrogen sorption material 34, hydrogen sorbed in/on the material is liberated again and for example converted into water in the already occurring catalytic reaction.

The incorporation/sorption of hydrogen described above and the catalytic reaction of hydrogen makes it possible to ensure that a gas G released to the environment contains only a small amount/concentration of hydrogen, thus avoiding the potential risk of ignition/explosion of excessively hydrogen-enriched gas. The energy liberated in the adsorption process and also in the catalytic reaction simultaneously ensures that the process for reacting hydrogen, which brings about the reduction in the hydrogen concentration, is activated and independently maintained even at low ambient temperatures of for example below 0° C. Since, at the same time, even the hydrogen sorbed at commencement of the process is desorbed again and catalytically reacted in this process the hydrogen sorption/catalyst unit 22 is regenerated during the process and is available for a further release cycle after the process has ended.

FIG. 2 shows that the hydrogen sorption/catalyst unit 22 may include an electrically energizable heating unit 38 for example. The unit may include one or more heat conductors coiling around the substrate 30 at an outer circumferential region which upon application of an electrical voltage generates heat, thus heating the substrate 30 and accordingly the hydrogen sorption material 34 provided thereupon and also the hydrogen catalyst material 36. Thus especially at very low ambient temperatures the heat introduced via the heating unit 38 in addition to the energy liberated in the adsorption process ensures very rapid activation of the catalytic reaction and thus oxidation of hydrogen/conversion thereof into water.

The adsorption of hydrogen at the hydrogen sorption material 34 may utilize various processes. The hydrogen sorption material 34 may for example include physisorption material in which the hydrogen is incorporated in the lattice structure of the physisorption material. Zeolite for example may be used as a material particularly suitable for the incorporation of hydrogen. In an alternative process/an alternative embodiment the hydrogen sorption material 34 may include chemisorption material in which the hydrogen is sorbed by a chemical reaction. Such a chemisorption material may for example include metal, for example lithium, a mixture of lithium and aluminum or a mixture of sodium and boron.

Each of these adsorption processes liberates heat and input of heat into the hydrogen sorption material 34 allows hydrogen bonded thereto as sorptive to be liberated again and then reacted/oxidized over the hydrogen catalyst material 36. Such hydrogen catalyst material 36 may include palladium and/or platinum.

It should finally be noted that various variations may be undertaken in the case of a hydrogen storage assembly 40 constructed according to the disclosure which includes as essential constituents one or more hydrogen tanks 18 and one or more hydrogen sorption/catalyst units 22. Accordingly, for example, the substrate 30 may have a different structure, for example a porous structure, and thus provide a multiplicity of intertwined/interconnected flow channels. The hydrogen-depleted gas G released from such a hydrogen sorption/catalyst unit 22 may also be released directly to the environment and not into a fuel cell offgas apparatus. It should further be emphasized that the hydrogen storage assembly 40 constructed according to the disclosure may find use not only in connection with a fuel cell system, in particular in a vehicle. Other, especially also stationary, apparatuses too can utilize such a hydrogen storage assembly 40 which provides for the possibility of repeatedly releasing gaseous hydrogen from one or more hydrogen tanks 18 and of releasing a hydrogen-depleted gas to the environment by way of the above-described process.

It is understood that the foregoing description is that of the preferred embodiments of the invention and that various changes and modifications may be made thereto without departing from the spirit and scope of the invention as defined in the appended claims.

1. A hydrogen storage assembly comprising:
at least one hydrogen tank for storing liquid hydrogen; and,
at least one hydrogen sorption/catalyst unit for sorption and catalytic conversion of gaseous hydrogen released from said at least one hydrogen tank.

2. The hydrogen storage assembly of claim 1, wherein:
said at least one hydrogen sorption/catalyst unit includes at least one substrate around which gaseous hydrogen flows; and,
hydrogen sorption material and hydrogen catalyst material are provided at said at least one substrate.

3. The hydrogen storage assembly of claim 2, wherein at least one of the following applies:
i) said at least one substrate is made with ceramic material; and,
ii) said at least one substrate includes a multiplicity of flow channels for accommodating a flow of gaseous hydrogen therethrough.

4. The hydrogen storage assembly of claim 3, wherein said at least one substrate has a surface defining said multiplicity of flow channels and includes said hydrogen sorption material and said hydrogen catalyst material on said surface defining said flow channels.

5. The hydrogen storage assembly of claim 2, wherein said at least one substrate defines a substrate surface and at least a portion of said substrate surface is coated with said hydrogen sorption material defining a surface and said hydrogen catalyst material is provided at least on said surface of said hydrogen sorption material.

6. The hydrogen storage assembly of claim 2, further comprising a heater assigned to said at least one substrate.

7. The hydrogen storage assembly of claim 6, wherein said heater is electrically energizable to provide heat.

8. The hydrogen storage assembly of claim 1, wherein said at least one hydrogen sorption/catalyst unit is configured for adsorption of hydrogen.

9. The hydrogen storage assembly of claim 8, wherein said at least one hydrogen sorption/catalyst unit is configured for adsorption of hydrogen; and, said hydrogen sorption material includes physisorption material.

10. The hydrogen storage assembly of claim 9, wherein said physisorption material comprises zeolite.

11. The hydrogen storage assembly of claim 2, wherein said at least one hydrogen sorption/catalyst unit is configured for adsorption of hydrogen; and, said hydrogen sorption material includes chemisorption material.

12. The hydrogen storage assembly of claim 11, wherein said chemisorption material comprises: metal, a mixture of lithium and aluminum or a mixture of sodium and boron.

13. The hydrogen storage assembly of claim 12, wherein said metal is lithium.

14. The hydrogen storage assembly of claim 1, wherein said at least one hydrogen sorption/catalyst unit is configured for catalytic oxidation of hydrogen.

15. The hydrogen storage assembly of claim 2, wherein said at least one hydrogen sorption/catalyst unit is configured for catalytic oxidation of hydrogen; and, said hydrogen catalyst material comprises palladium and/or platinum.

16. The hydrogen storage assembly of claim 1, wherein said hydrogen storage assembly is for a fuel cell system in a vehicle.

17. A fuel cell system comprising:
at least one fuel cell having an anode region; and,
a hydrogen storage assembly for supplying gaseous hydrogen to said anode region of said at least one fuel cell;
said hydrogen storage assembly including:
at least one hydrogen tank for storing liquid hydrogen; and,
at least one hydrogen sorption/catalyst unit for sorption and catalytic conversion of gaseous hydrogen released from said at least one hydrogen tank.

18. The fuel cell system of claim 17, wherein said fuel cell system is for a vehicle.
